(19) United States
(12) Patent Application Publication
(10) Pub. No.: US 2025/0187896 A1
(43) Pub. Date: Jun. 12, 2025

(54) AUTOMATED MULTI-BEVERAGE DISPENSER WITH SELF-CLEANING

(71) Applicant: The Middleby Corporation, Elgin, IL (US)

(72) Inventors: Tanuj Siddharth, Fremont, CA (US); Gillian Callaghan, Vero Beach, FL (US); Patrick Salazar, Novi, MI (US); Shawn Lange, Walnut Creek, CA (US); Varun Rallabandi, Troy, MI (US); Refugio Ponce, San Jose, CA (US); Jake Lockwood, Bayville, NJ (US); Dustin Hartsfield, Sebastian, FL (US)

(21) Appl. No.: 18/977,884

(22) Filed: Dec. 11, 2024

Related U.S. Application Data
(60) Provisional application No. 63/608,753, filed on Dec. 11, 2023.

(51) Int. Cl. B67D 1/07

(52) U.S. Cl. CPC B67D 1/07

(57) ABSTRACT

Example systems and methods are directed to cleaning systems for an automated beverage dispenser. A plurality of beverage preparation areas or cleaning areas may be provided with pressurized fluid from a cleaning medium source via a fluid supply line. The cleaning system further comprises a first controllable constant flow valve for providing pressurized fluid to the cleaning medium. A second controllable constant flow valve provides an output of the cleaning medium source to a cleaning area. The first controllable constant flow valve may be enabled at a first time associated with a beginning of a cleaning cycle of the first cleaning area. The second controllable constant flow valve may be enabled thereafter. The first controllable constant flow valve and the second controllable constant flow valve may be disabled after an end of the cleaning cycle of the first cleaning area.

### CROSS-REFERENCE TO RELATED APPLICATIONS

This application claims the benefit of U.S. Provisional Patent Application No. 63/608,753, filed Dec. 11, 2023, the disclosure of which is hereby incorporated by reference herein in its entirety for all purposes.

### BACKGROUND

Beverage dispensing systems may assist with dispensing of beverages such as coffees, waters, seltzers, sodas, and/or mixed alcoholic drinks with a variety of degrees of complexity and automation. Merely as examples, preparing a “coffee” beverage may include numerous variations of dairy, non-dairy creamers, ground coffee, aerated liquids, and other ingredients in a variety of combinations with differing preparation profiles. A “soda” or “seltzer” dispenser may include numerous combinations of base liquids, sweeteners, flavors, carbonation sources, and the like. Commercial beverage companies continue to supply, and consumers continue to purchase, an ever-increasing variety of beverage combinations and infusions. Beverage dispensing systems have traditionally provided a limited set of beverage options, such that the addition or modification of beverage types or recipes requires significant changes to the beverage dispensing system such as modifications to programming or machine components. Further, customer options for customization are limited. Moreover, different dispensing components and dispensed mediums may have disparate requirements for maintenance and/or cleaning. Accordingly, there is a need for a beverage dispensing system that provides flexibility, user-friendliness, and simplicity of cleaning and maintenance.

### SUMMARY

In at least some example illustrations, a cleaning system for an automated beverage dispenser comprises a plurality of beverage preparation areas and a fluid supply line. The fluid supply line provides a fluid path for a pressurized fluid. The cleaning system also comprises a cleaning medium source. The cleaning system also comprises a first controllable constant flow valve located between the fluid supply line and the cleaning medium source. Activating the first controllable constant flow valve allows the pressurized fluid to be provided to the cleaning medium source at a first flow rate of the first controllable constant flow valve such that an output of the cleaning medium source has a particular concentration of the cleaning medium. The cleaning system also comprises a second controllable constant flow valve coupled to the output of the cleaning medium source to provide the output of the cleaning medium source with the particular concentration to a first beverage preparation area of the plurality of beverage preparation areas at a second flow rate of the second controllable constant flow valve. The cleaning system further comprises processing circuitry in communication with the first controllable constant flow valve and the second controllable constant flow valve. The processing circuitry is configured to enable, at a first time associated with a beginning of a cleaning cycle of the first beverage preparation area, the first controllable constant flow valve. The processing circuitry is also configured to enable, at a second time after the first time and while the first controllable constant flow valve remains enabled, the second controllable constant flow valve. The processing circuitry is also configured to disable, after an end of the cleaning cycle of the first beverage preparation area, the first controllable constant flow valve and the second controllable constant flow valve.

In at least some example approaches, a cleaning system for an automated beverage dispenser comprises a plurality of cleaning areas, a fluid supply line that provides a fluid path for a pressurized fluid, and a cleaning medium source. The cleaning system further comprises a first controllable constant flow valve located between the fluid supply line and the cleaning medium source, wherein activating the first controllable constant flow valve allows the pressurized fluid to be provided to the cleaning medium source at a first flow rate of the first controllable constant flow valve such that an output of the cleaning medium source has a particular concentration of the cleaning medium. The cleaning system also comprises a second controllable constant flow valve coupled to the output of the cleaning medium source to provide the output of the cleaning medium source with the particular concentration to a first cleaning area of the plurality of cleaning areas at a second flow rate of the second controllable constant flow valve. The cleaning system further comprises processing circuitry in communication with the first controllable constant flow valve and the second controllable constant flow valve. The processing circuitry is configured to enable, at a first time associated with a beginning of a cleaning cycle of the first cleaning area, the first controllable constant flow valve. The processing circuitry is further configured to enable, at a second time after the first time and while the first controllable constant flow valve remains enabled, the second controllable constant flow valve. The processing circuitry is configured to disable the first controllable constant flow valve and the second controllable constant flow valve after an end of the cleaning cycle of the first cleaning area.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1 is a schematic view of an automated cleaning system for a beverage dispenser, in accordance with some embodiments of the disclosure;

FIG. 2 is a perspective view of an example alkaline and acid cleaner for the automated cleaning system of FIG. 1, in accordance with some embodiments of the disclosure;

FIG. 3 is a perspective view of an example constant flow valves for the automated cleaning system of FIG. 1, in accordance with some embodiments of the disclosure;

FIG. 4 is a perspective view of an example water dilution system for the automated cleaning system of FIG. 1, in accordance with some embodiments of the disclosure;

FIG. 5 is a perspective view of an example liquid traffic spine subsystem for the automated cleaning system of FIG. 1, in accordance with some embodiments of the disclosure;

FIG. 6 is another perspective view of the example liquid traffic spine subsystem of FIG. 5, in accordance with some embodiments of the disclosure;

FIG. 7 is a perspective view of an example XT brew group integration for the automated cleaning system of FIG. 1, in accordance with some embodiments of the disclosure;

FIG. 8 is a perspective view of an example coffee brew group and nitro integration for the automated cleaning system of FIG. 1, in accordance with some embodiments of the disclosure;

FIG. 9 is a perspective view of the automated cleaning system of FIG. 1, in accordance with some embodiments of the disclosure;

FIG. 10 is a perspective view of an example bucket connection for the automated cleaning system of FIG. 1, in accordance with some embodiments of the disclosure;

FIG. 11 is a schematic view of an automated cleaning system for a beverage dispenser, in accordance with some embodiments of the disclosure;

FIG. 12 is a perspective view of an example XT brew chamber mounting for the automated cleaning system of FIG. 1 or 11, in accordance with some embodiments of the disclosure;

FIG. 13 is a perspective view of an example AT brew chamber mounting for the automated cleaning system of FIG. 1 or 11, in accordance with some embodiments of the disclosure;

FIG. 14 is a perspective view of an automated cleaning system for a beverage dispenser, in accordance with some embodiments of the disclosure;

FIG. 15 is a schematic view of an automated cleaning system for a beverage dispenser, in accordance with some embodiments of the disclosure;

FIG. 16 is a perspective view of a cabinet for an automated cleaning system for a milk dispensing system of a beverage dispenser, in accordance with some embodiments of the disclosure;

FIG. 17 is a perspective view of a manifold and/or valve assembly for the cabinet of FIG. 16, in accordance with some embodiments of the disclosure;

FIG. 18 is a perspective view of an automated door system for a beverage dispensing system having an automated cleaning system, in accordance with some embodiments of the disclosure;

FIG. 19 is a front perspective view of a beverage dispensing system having an automated door system, in accordance with some embodiments of the disclosure;

FIG. 20 is another front perspective view of the beverage dispensing system of FIG. 19, in accordance with some embodiments of the disclosure;

FIG. 21 is another front perspective view of the beverage dispensing system of FIGS. 19 and 20, in accordance with some embodiments of the disclosure;

FIG. 22 is a front perspective view of an automated door system for an automated beverage dispensing system, in accordance with some embodiments of the disclosure;

FIG. 23 is another perspective view of the automated door system of FIG. 22, in accordance with some embodiments of the disclosure;

FIG. 24 is a perspective view of the automated door system of FIGS. 22 and 23, in accordance with some embodiments of the disclosure;

FIG. 25 is a perspective view of the automated door system of FIGS. 22-24, in accordance with some embodiments of the disclosure; and

FIG. 26 is a process flow diagram for an example automated cleaning process for a beverage dispensing system, in accordance with some embodiments of the disclosure.

### DETAILED DESCRIPTION

In example approaches, beverage dispensing systems may include a plurality of subsystems for respective different consumable mediums, with the consumable mediums being combined to create a beverage. For example, dispensed beverages may include a combination of milk and coffee (e.g., to create a cappuccino, latte, coffee with cream, etc.), and/or one or more syrups. Furthermore, coffee products may be dispensed in aerated form, e.g., and/or an aerated liquid such as a nitro cold brew coffee beverage. Seltzers and sodas may include a variety of sweeteners, flavors, base liquids, and carbonation sources. Mixed drinks may include infusion of alcoholic beverages or other sources with a variety of beverages, mixers, flavor and/or ingredients. Increasingly, consumers are purchasing beverages that include a variety of combinations of category types, such as coffee-infused beverages.

Generally coffee vending machines may tend to require frequent maintenance and are sensitive to a lack of maintenance such that the vending machines frequently break down. Daily cleaning is typically required. Additionally, coffee brewing machine manufacturers may monitor usage of cleaning tablets used to clean a machine, and if a machine is not cleaned relatively frequently to meet their standards, a customer may risk voiding applicable warranties by the manufacturer. In examples herein, an automated regular (e.g., nightly) cleaning process for an automated beverage machine is employed that generally requires little to no input from an operator of the automated beverage machine.

In examples herein, a liquid cleaner is employed rather than cleaning tablets. The examples herein employ different types of solutions with appropriate dwell times to properly disinfect and remove any remaining ground beans from brewing systems. Cleaning tablets may tend to develop a puck that is relatively easy to sweep from a machine during cleaning. However, this generally requires additional flushing and cleaning compared with example approaches herein where a solution/liquid is employed.

Cleaning of milk dispensing systems has additional difficulties inherent in storage and distribution of milk. Milk cleaning may be relatively time-consuming, e.g., requiring a time period of 15-30 minutes to execute appropriate cleaning. In examples herein, three general phases are included in a milk cleaning process, including an acid cleaning phase, an alkaline sanitizing phase, and a water rinsing phase. Other cleaning fluids or solutions may be employed to accomplish cleaning, sanitizing, and rinsing phases.

Additionally, milk lines or conduits will tend to experience curdling or may otherwise spoil (in some cases, increasing risks of bacterial infection such as Escherichia coli, i.e., E coli) if not kept in appropriate temperature range, e.g., between 32 degrees Fahrenheit and 41 degrees Fahrenheit. Furthermore, even with this relatively tight temperature range, distribution lines generally cannot be greater than eighteen (18) inches in length.

Accordingly, example cleaning processes herein for milk distribution systems may employ an automated regular (e.g., nightly) cleaning that accomplishes all three cleaning/sanitizing/rinsing phases in a single bucket or other container. In at least some example milk cleaning processes, a manual operator or service personnel need only to exchange milk containers (e.g., gallon jugs) with a cleaning bucket. More specifically, conduits employed to draw milk from the containers may be removed from the containers and placed into the cleaning bucket. Subsequently, the service personnel may actuate the automated cleaning system, which then automatically cleans, sanitizes, and rinses the conduits of the milk distribution system.

In example approaches herein, automated cleaning processes generally adhere to applicant guidelines for sanitation, such as the guidelines set forth by the National Sanitation Foundation (NSF), e.g., NSF 159, 18, 4, 12, 2 and 51 as described further below. Milk dispensing systems, for example, may be cleaned using an automated process that meets NSF 18 for milk guidelines. Additionally, the automated cleaning system is configured to detect an amount of cleaner used, while still utilizing typical steam and sanitation processes. Other applicable NSF standards may include, but are not necessarily limited to, NSF 169 (“Special Purpose Food Equipment and Devices”), NSF 18 (“Manual Food and Beverage Dispensing Equipment,” applicable to milk/syrup dispensing systems), NSF 4 (“Commercial Cooking, Rethermalization and Powered Hot Food Holding and Transport Equipment,” applicable to coffee machines), NSF 12 (“Automatic Ice Making Equipment”), NSF 2 (“Food Equipment,” applicable to frame/build), and/or NSF/ANSI 51 (“Food Equipment Materials”).

In one aspect of the present disclosure, example illustrations herein are directed to systems and methods for automated cleaning of an automated liquid dispenser, such as a hot or cold beverage dispenser. Example systems may generally provide different cleaning fluids to each subsystem, as may be appropriate for respective mediums dispensed by each subsystem and the components of the subsystem. Merely as one example, a milk dispensing subsystem may require different types and/or concentrations of a cleaning fluid, and may also have a different cleaning frequency, than for a coffee/brewing subsystem. Components of the system (e.g., tubes, valves, etc.) may be modular, replaceable, or updateable, and may have their own differing cleaning requirements. Accordingly, example automated cleaning systems may supply different cleaning fluids to the different subsystems with different timing and methodologies.

Additionally, example approaches may employ active cleaning ingredients that are combined or applied in a controllable manner to implement different cleaning fluids or strategies (e.g., flow rate, pressure, temperature, etc.). For example, one or more active cleaning ingredients may be applied directly, in a diluted form, to the plurality of medium dispensing subsystems. In some examples, a concentrated acid may be applied directly to some medium dispensing subsystems, while being applied in diluted form or in combination with other cleaning fluids to another medium dispensing subsystem. Accordingly, example approaches may apply multiple cleaners in modular fashion that facilitates implementation in different beverage dispensing systems. Further, heat, flow rate, and pressure may be modified by selectively routing liquids to appropriate components.

An example auto-cleaning system may include a variety of components that are controllable to facilitate the controlled supply of cleaning agents (e.g., cleaners, solvents, detergents, concentrates, acids, alkalines, etc.) in accordance with a targeted sub-system to be cleaned. Accordingly, a single auto-cleaning system may provide updateable and controllable cleaning to each of a variety of sub-systems that each have their own unique requirements for cleaning agents, cleaning time, heating, pressure, and the like, which in turn may change over time and be updateable within the system with relatively simple modifications implemented via commands provided by a GUI or API.

The system may measure and store information about system operations to trigger and control cleaning cycles. For example, information about the timing, frequency, intensity, efficiency and contents of dispensing cycles can be captured and analyzed to determine when to perform a cleaning cycle. Cleaning cycles can be scheduled and repeated based on predetermined criteria such as a number of cycles, passage of time, environmental conditions (temperature, humidity, etc.), types of beverages dispensed, materials of dispensing paths, or a combination thereof (e.g., a number of dispensing cycles as a first threshold and if that is not met a timing threshold), for example, cleaning dairy systems after a number of uses or at least daily, brewing systems after a number of uses or at least every other day, and two weeks or more for cold brewers. In some instances, a cleaning cycle may be configured to run within a period of time after the actual trigger point, for example, to monitor for a break in usage suitable to perform cleaning with minimal interference in dispensing operations. The system may integrate with the dispense engine's firmware and communication protocol to manage automated triggers as required by different sequences. Accordingly, the system may have timers, counters, and runout checks to ensure full end-to-end cleaning is resolved and can trigger messages to the user interface for a user or technician to perform necessary actions. The software program can collect the data and make it available for remote Internet-of-Things (IOT) data access to determine usage trends and proactively capture any failures. The user interface allows single touch triggers and can navigate through the cleaning itself with minimal interventions.

In some instances, feedback on the quality of the cleaning provided to a particular sub-system may be received directly (e.g., by measurement of flow rates, sampling of liquids output, direct monitoring of components, etc.) and/or indirectly (e.g., based on user feedback or ratings) and may be utilized to adjust cleaning parameters using components and systems as described herein. In some examples, feedback may be utilized to confirm that food safety regulations and user-specified requirements or met in an automated process, providing dynamic adjustments to cleaning parameters as necessary. Examples of sensors, systems, and techniques for obtaining feedback and controlling operations of beverage dispensing devices are provided in U.S. Pat. No. 11,673,788, entitled “BEVERAGE DISPENSING AND MONITORING SYSTEM” and filed on Feb. 3, 2020, and U.S. Pat. No. 11,247,891, entitled “CONNECTED AND AUTOMATED LIQUID DISPENSING ATTACHMENT” and filed on Aug. 14, 2020, each of which is incorporated by reference in its entirety.

An example auto-cleaning system utilizes a variety of components to enable controlled and modifiable cleaning of multiple sub-systems. As an example, precision control flow valves maintain consistencies in flow rate and manage quantities of cleaner mediums for concentrate and diluted applications.

The valves may be configured (inline, alternating and individual) to operate with corresponding plumbing fittings, tube types, tube lengths, and the like, which in turn can be updated and modified with the control of the valves updated in a corresponding manner. The example system may also utilize custom bucket designs for optimizing user access to items to be cleaned via immersion or targeted application of pressurized cleaning fluid (e.g., bottles, canisters, etc.). These components are configured for different machines and combinations, and the controls of all components can be updated and modified via modifications to the control and operation of valves and other components (e.g., heaters, etc.). Components such as connections to cleaner canisters are designed to be quick connect and adjustable such that they can be easily replaced by operators at different frequencies. Moreover, valves are consolidated for cleaning medium generation and distribution control. In this manner, the system is modular and can be reconfigured to different cleaning mediums, dispense quantities and distribution controls and dispense engine plumbing configurations custom to each machine and application.

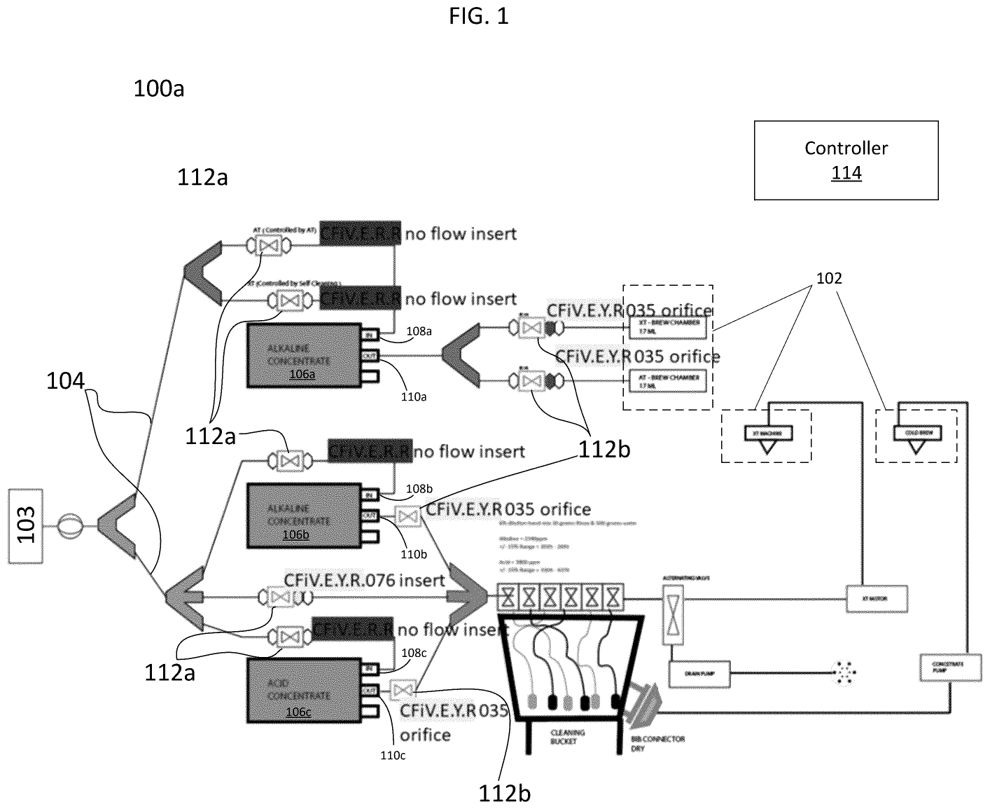

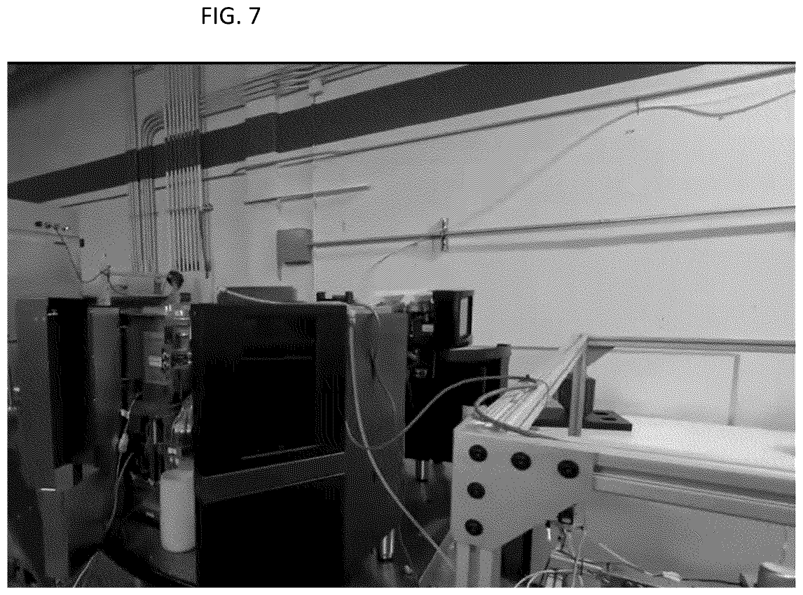

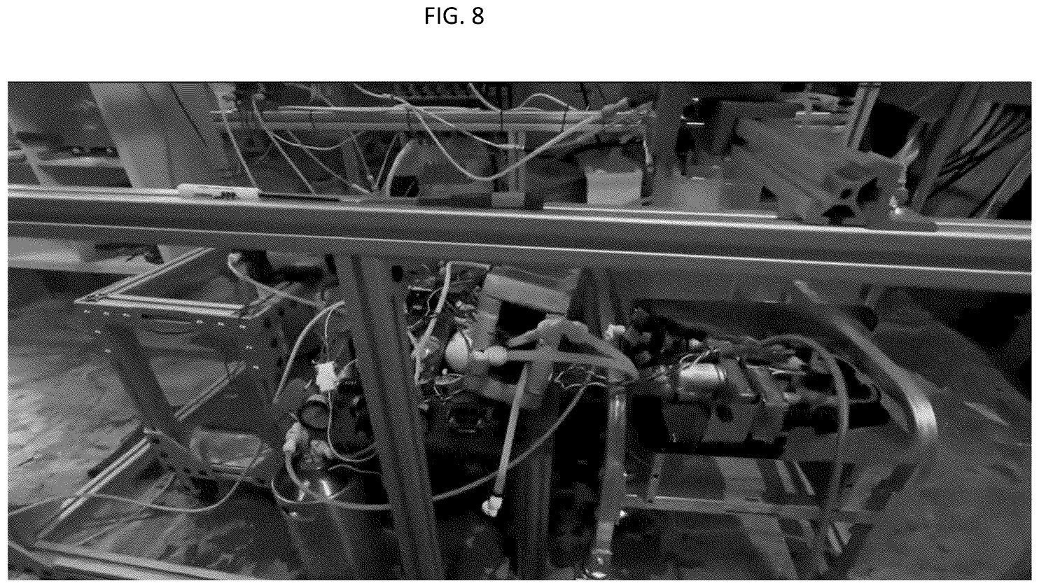

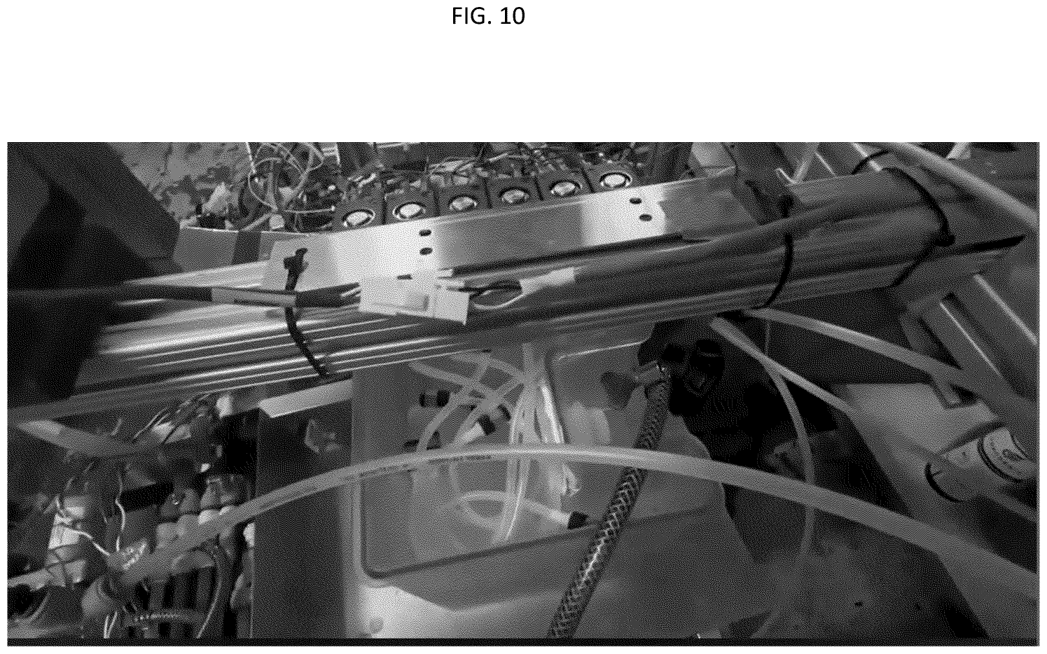

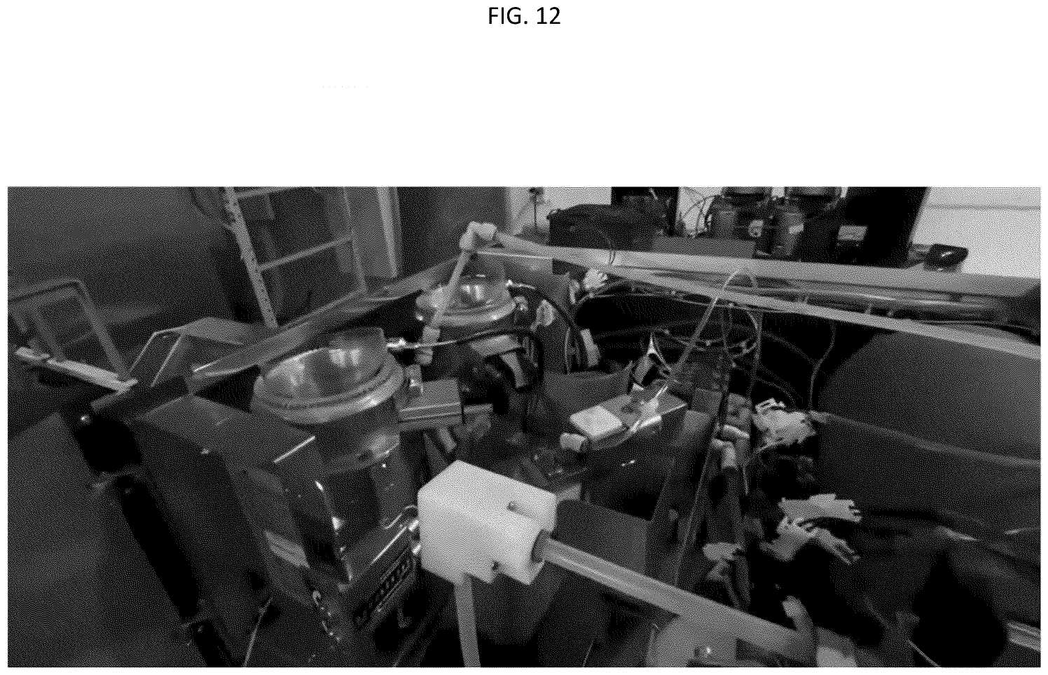

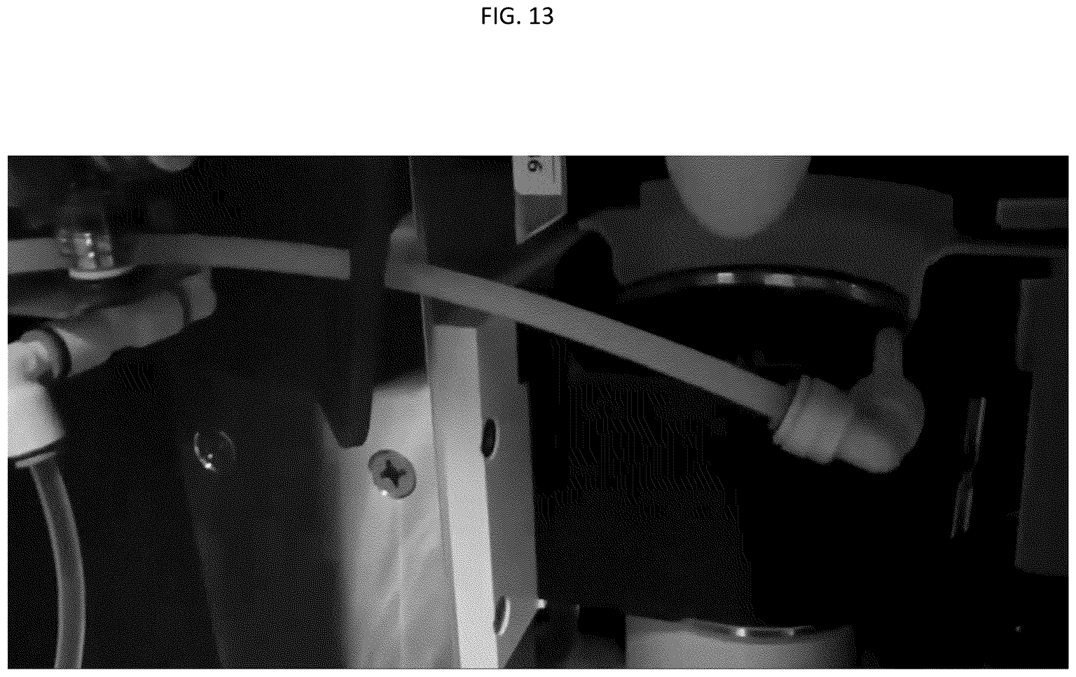

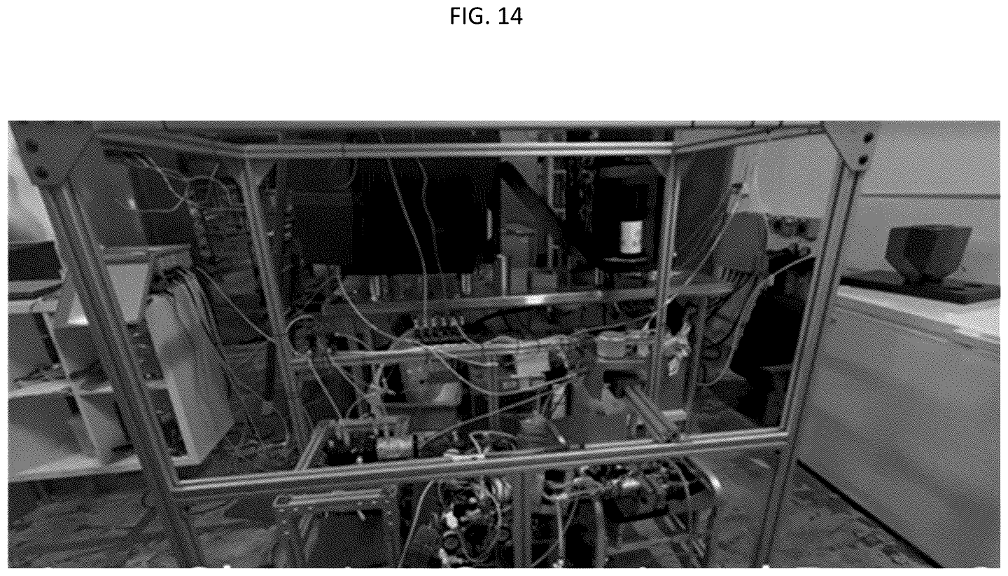

Referring now to FIGS. 1-15, an integrated cleaning system 100 is illustrated and described in further detail. Generally, the system may have multiple cleaning concentrate and diluted solution dispense systems. Additionally, controlled flow relays may be employed to facilitate accurate measurement and flow planning. Furthermore, example systems may be automated to provide programmable sequencing and distribution control, facilitating integration with existing and future liquid dispense technologies such as grinding brewing systems, aerated dispensers (e.g., kegs, nitro, carbonated, etc.) and low viscosity and high viscosity liquids (e.g., milks, water, syrups, etc.).

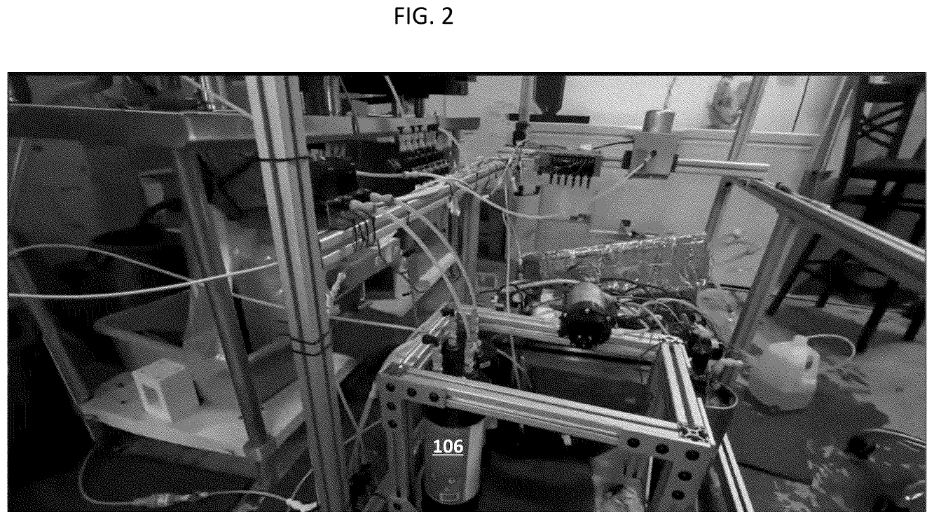

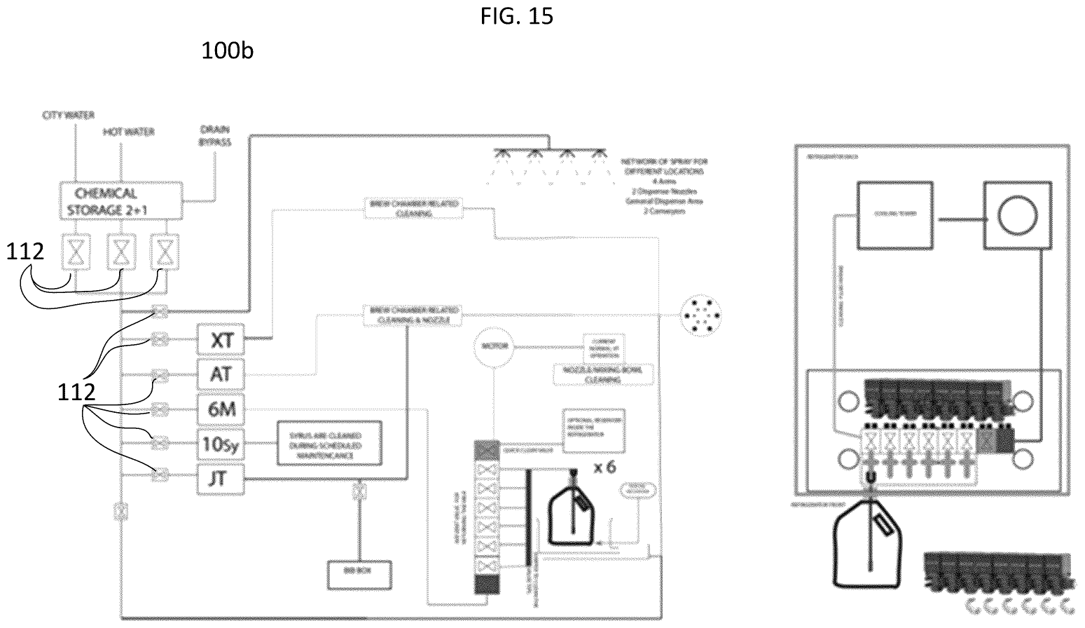

A first integrated cleaning system 100a is illustrated schematically in FIG. 1, with images of example components in FIGS. 2-10 and 12-14. Another example system 100b is illustrated in FIG. 15. Generally, the systems 100 illustrated in FIGS. 1 and 15 include a plurality of beverage preparation areas 102 having components that may be periodically cleaned. For example, one or more fluid supply lines 104 (e.g., supplying water under pressure from water supply 103, e.g., a city supply, well, or the like) may generally be employed to drive fluid and cleaning agents toward/to the beverage preparation areas 102 to facilitate cleaning and/or disinfecting of beverage supply components such as nozzles, hoses, pumps, heaters, or other conduits, etc. Cleaning may generally rinse remnants of dispensed beverages from the components, and/or may disinfect the components.

Generally, the fluid supply line(s) 104 provides a fluid path for a pressurized fluid (e.g., water) that may be used to circulate a cleaning agent or solution to a beverage dispensing area 102 and components thereof such as nozzles, hoses, pumps, heaters, conduits, or the like. In the illustrated example of FIG. 1, a plurality of cleaning sources 106a, 106b, and 106c (collectively, 106) are provided, which may be fed pressure and/or water from the fluid supply line 104 to facilitate flow of cleaning fluids or agents to one or more of the beverage preparation areas 102. The cleaning sources 106 may include alkaline concentrates 106a and 106b, or acid concentrates 106c, merely as examples. The alkaline/acid concentrates may be distributed by supplying water from the supply lines 104 to inlets 108a, 108b 108c, respectively, circulating the water through an interior of the cleaning sources 106 at a particular flow rate and/or pressure, and causing alkaline/acid to be infused or entrained in the flow of water from respective outlets 110a, 110b, 110c of the cleaning source(s) 106. The alkaline/acid may flow in a diluted form from the cleaning source 106 based on the flow rate such as is provided via a constant flow valve. The concentrate may be mixed with water or other solutions downstream of the outlet, creating diluted alkaline/acid cleaning agents that may be used for cleaning, as will be described further below.

A plurality of controllable constant flow valves 112 may be used to supply the cleaning medium or agent from the cleaning sources. As noted above, controllable constant flow valves may generally provide a predetermined or desired volumetric flow rate upon actuation and supply of an inlet pressure. By metering flow through the valves, e.g., by limiting flow to a desired maximum volumetric flow, cleaning agents or diluted cleaning agents may be circulated to beverage dispensing components in a precise manner. Accordingly, sufficient cleaning and/or disinfecting of beverage components may be accomplished, with minimal waste due to excessive cleaning agent usage and more accurate cleaning due to precise control of mixing and dilution.

As noted above, a plurality of controllable constant flow valves 112 are employed in the example illustrated in FIG. 1 between the fluid supply line and cleaning medium sources, as well as between outputs of the cleaning medium sources and beverage components. As illustrated in FIG. 1, controllable constant flow valve(s) 112a located between the fluid supply line 104 and the cleaning medium source(s) 106 may selectively block flow and allow flow of the pressurized fluid to be provided to cleaning medium source(s) 106 at a specific flow rate of the controllable constant flow valve 112. Further, an output 110 of the cleaning medium source 106 may have a particular concentration of the cleaning medium based upon, for example, the flow rate permitted by the valves 112a, concentration of the cleaning medium source 106, etc. Additional controllable constant flow valve(s) 112b may be coupled to the output 110 of the cleaning medium source 106 to provide the output 110 of the cleaning medium source with the particular concentration to a first beverage preparation area 102 of the plurality of beverage preparation areas 102 at a flow rate of the second controllable constant flow device 112b. Actuation of any of the valves 112a and 112b may be executed by a controller 114, as illustrated schematically in FIG. 1. The controller 114 may include processing circuitry in communication with the first controllable constant flow valve(s) 112a and the second controllable constant flow valve(s) 112b to actuate the valves 112. For example, at a first time associated with a beginning of a cleaning cycle of a first one of the beverage preparation areas 102, the processing circuitry 114 may enable the first controllable constant flow valve 112a. Subsequently, at a second time after the first time and while the first controllable constant flow valve 112a remains enabled, the second controllable constant flow valve 112b may be enabled by the processing circuitry 114. After an end of the cleaning cycle of the first beverage preparation area 102, the processing circuitry 114 may disable the first controllable constant flow valve 112a and the second controllable constant flow valve 112b, thereby discontinuing flow.

As illustrated in FIG. 1, example integrated cleaning systems 100 may generally include multiple modular components or subsystems. More specifically, the system 100 includes a cleaner dispense subsystem comprising the cleaning sources 106, a distribution and control subsystem configured to actuate valves 112 to cause creation of concentrated cleaners and diluted cleaners using the cleaning sources 106 and water supply 103, and a dispense engine cleaning subsystem configured to deliver concentrated cleaners and diluted cleaners to beverage preparation areas 102 for cleaning components of the beverage distribution system.

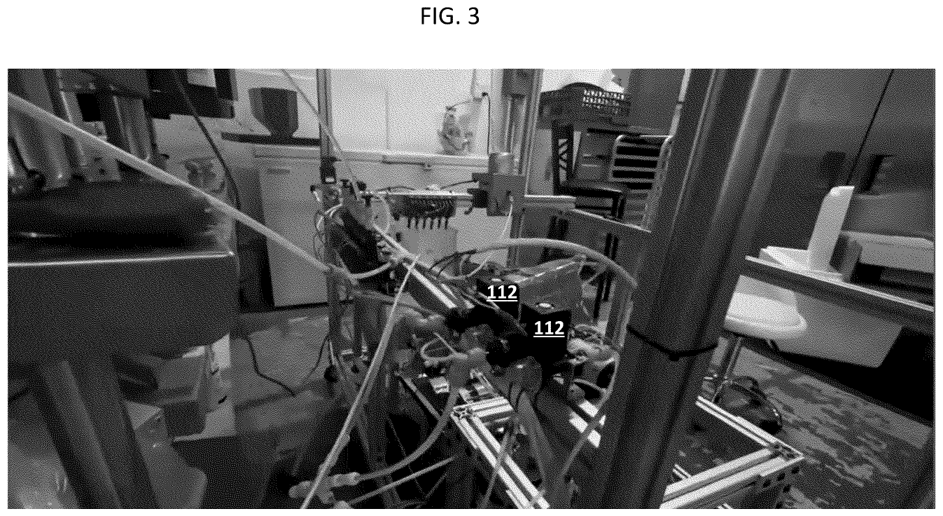

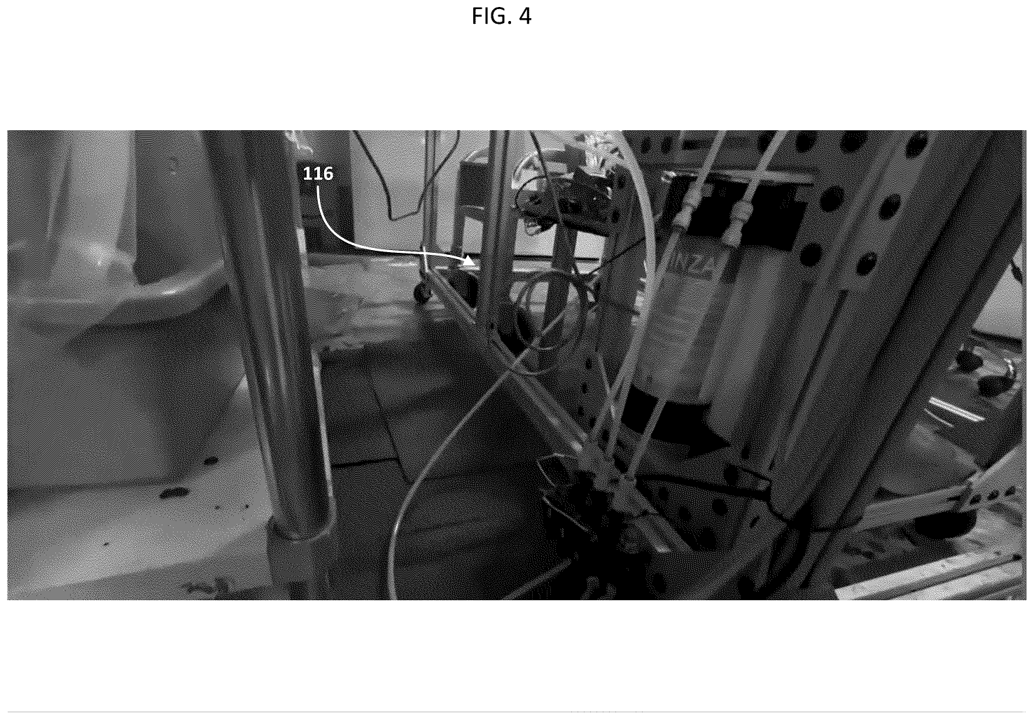

As generally described above, the cleaner dispense subsystem may generally be configured to provide a plurality of different cleaning solutions, fluids, or agents using one or more concentrated cleaning agents and a supply of a diluting fluid such as water (e.g., from city water or other fluid supply line). In the illustrated example, cleaning sources 106 include cleaner canisters containing an alkaline or an acid material that may be mixed with water to form cleaning agents or liquids in various concentrations. Example alkaline and acid cleaners are also illustrated in FIG. 2. As noted above controlled flow valves 112 may be provided to facilitate supply of the cleaners (e.g., alkaline or acid) in appropriate amounts and concentrations. Example ratio control valves 112 and a water dilution system 116 configured to dilute concentrated cleaning agents to create diluted alkaline or acid solutions are illustrated in FIGS. 3 and 4. A controller, e.g., having processing circuitry comprising a computer-readable medium and/or processor configured to implement methods and/or steps thereof as described herein, may actuate the valves on/off as needed to generate desired quantities of cleaning fluids and/or water using one or more programmed recipes. Accordingly, the cleaner dispense subsystem generally produces one or multiple combinations of cleaning agents, such as:
1. concentrated cleaners: CFV valve 112 plumbed to a water supply 103 (e.g., city water) controls the flow into the canister 106 to directly push concentrate (i.e., a relatively concentrated mixture of water and the alkaline/acid cleaner) out from the canisters 106. The timing of the valve 112 opening may control a quantity of the liquid that will be available to the distribution system.
2. diluted cleaners: CFV valves 112 may mix the concentrated water/cleaner mixture downstream of the cleaning source outlet with water from the water supply 103 to dilute the concentrated mixture of water/cleaner. In an example, dilution is based on total dissolved solids (TDS) readings which are communicated to the controller/processing circuitry.

The concentrates may be provided in canisters 106 and as noted above may include an acid, alkaline, or any other detergent or cleaning agent as its contents. Generally, the processor 114 may time actuation of appropriate valve(s) and plumbing fixture(s) to provide a repeatable flow of the various cleaning fluids as needed.

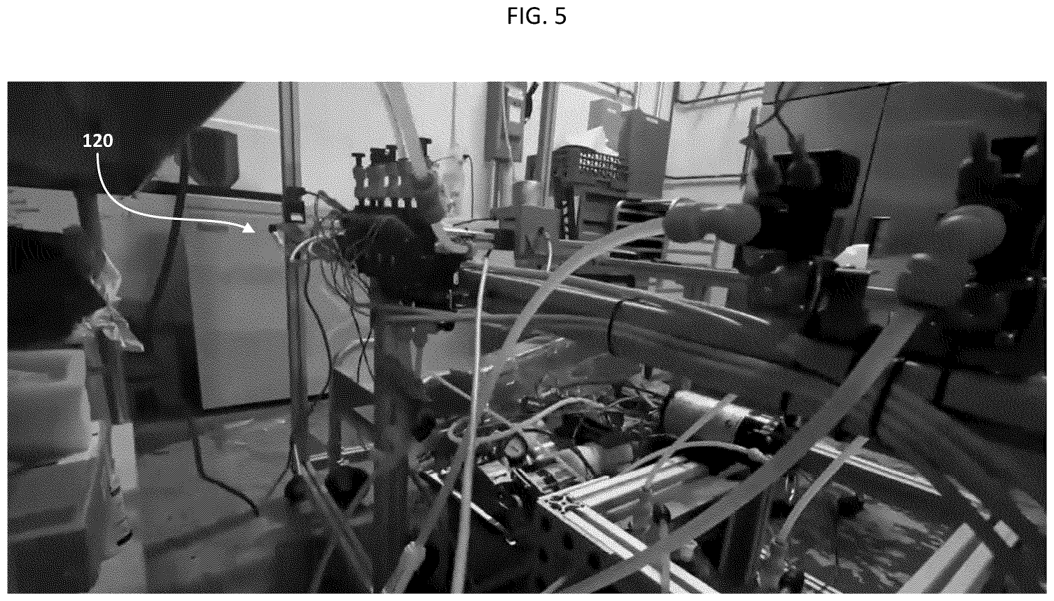

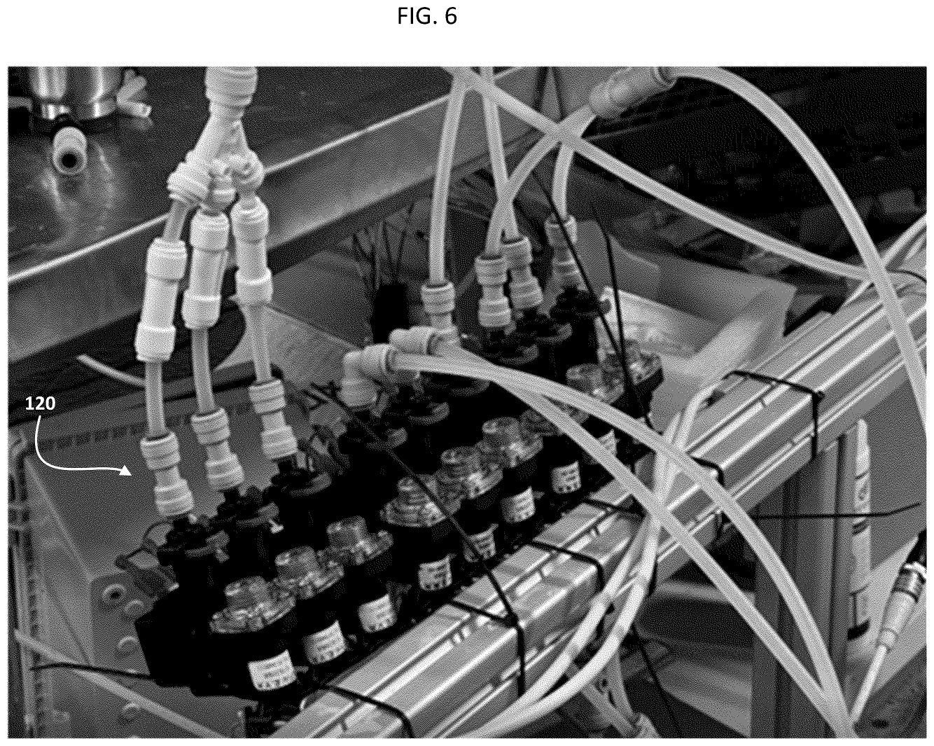

The distribution control and sequencing subsystem may provide the various formulated cleaner mediums in a regulated and ordered manner from the cleaning sources 106 to different beverage dispensers 102 in an integrated machine. For example, in the illustrated example of FIG. 1, alkaline concentrates may be used to clean brewing chambers in coffee machines (in relatively concentrated or lesser-diluted fluid flows), e.g., at a first one of the cleaning areas 102. An example liquid traffic spine subsystem 120 configured to direct cleaners from cleaning source(s) to beverage preparation area(s) is illustrated in FIGS. 5 and 6. Additionally, a diluted acid and alkaline mixture may be provided to clean a milk dispense subsystem and a cold brew system. Generally, the distribution control and sequencing subsystem may have a preset of valves, e.g., valves 112, that open collectively to guide the correct concentrates, liquids, and quantities to different machines or subsystems within the illustrated system. For example, as noted above initially processing circuitry 114 may open valves 112a upstream of the cleaning sources to cause water to flow into the cleaning sources 106. Subsequently, valves 112b downstream of the cleaning sources 106 may allow concentrated cleaners to be emitted from the cleaning sources 106. Additional valve(s) 112 further downstream of the cleaning sources 106 may (1) direct concentrated cleaners (e.g., alkaline or acid mixed with water) to a beverage preparation area 102, (2) cause the concentrated cleaners to be mixed with additional water to create diluted cleaners, and/or (3) direct the diluted cleaners to a beverage preparation area 102. These operations allow the delivery of the correct medium to different dispense engines and/or cleaning areas 102. Additionally, each of the dispense engine's internal commands may be triggered to perform the cleaning of the respective dispense engine.

The dispense engine cleaning subsystem may generally be configured to apply the different cleaning fluids/mediums to respective dispense engines of each subsystem. As noted above, the illustrated example of FIG. 1 includes a brew subsystem or engine, a milk subsystem, and a cold brew subsystem.

In the illustrated examples, a brewing subsystem may include one or more brew engines. For example, in the system of FIG. 15, multiple different types of brewing devices or engines may be provided that are configured to prepare respective different coffee beverages, and accordingly the different brewing devices may require appropriate brew chamber cleaning. In the illustrated example, a first “XT” brewing subsystem is directed to relatively faster coffee beverage preparation and includes a relatively limited range of beverages, e.g., without milk/dairy additives, syrups, etc. A second “AT” brewing subsystem, by contrast, is optimized around specialty coffees or coffees that integrate milk or syrups such as cappuccino, mocha, or similar beverages. Accordingly, the XT and AT beverage subsystems may require somewhat different cleaning schedules or cleaning liquids corresponding to the different ingredients typically employed in each subsystem. After the desired cleaning medium (e.g., alkaline concentrate) is supplied to the subsystem, the processor may trigger the cleaning commands of the subsystem or machines. These cleaning commands may include, e.g., a sequence of pump triggers, steam triggers, hot water dispense triggers and holding the cleaning liquid in pipes, or any other commands that are convenient to clean up particulate matter and sanitize the plumbing and fittings. Further, as noted above processing circuitry may actuate the valves to create appropriate cleaning agents and distribute to the beverage preparation areas.

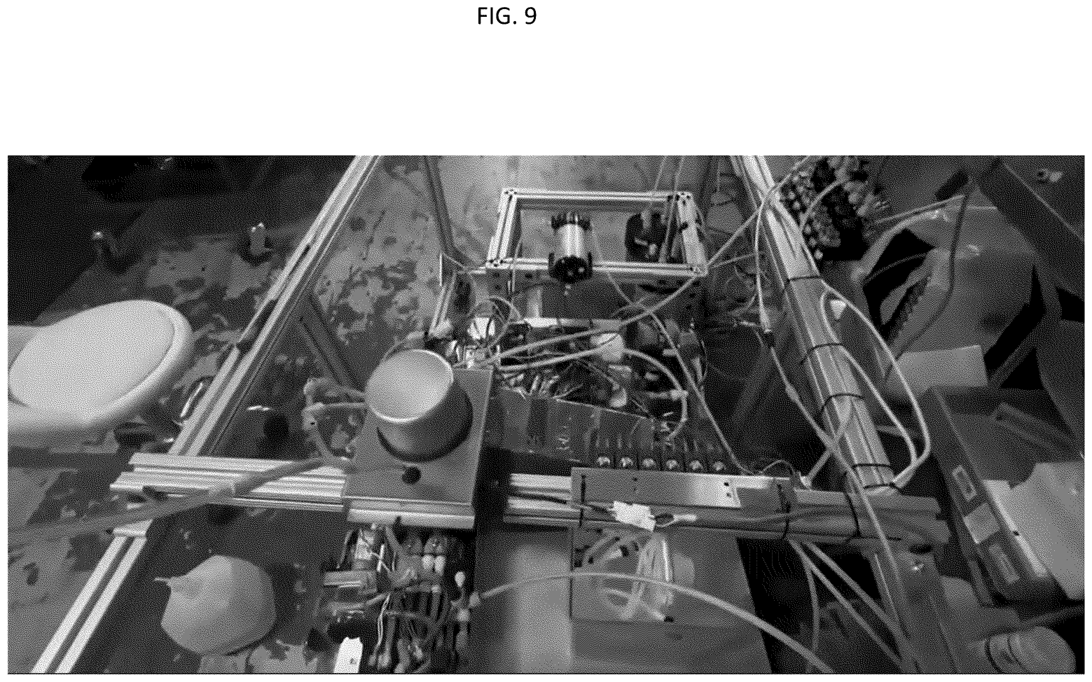

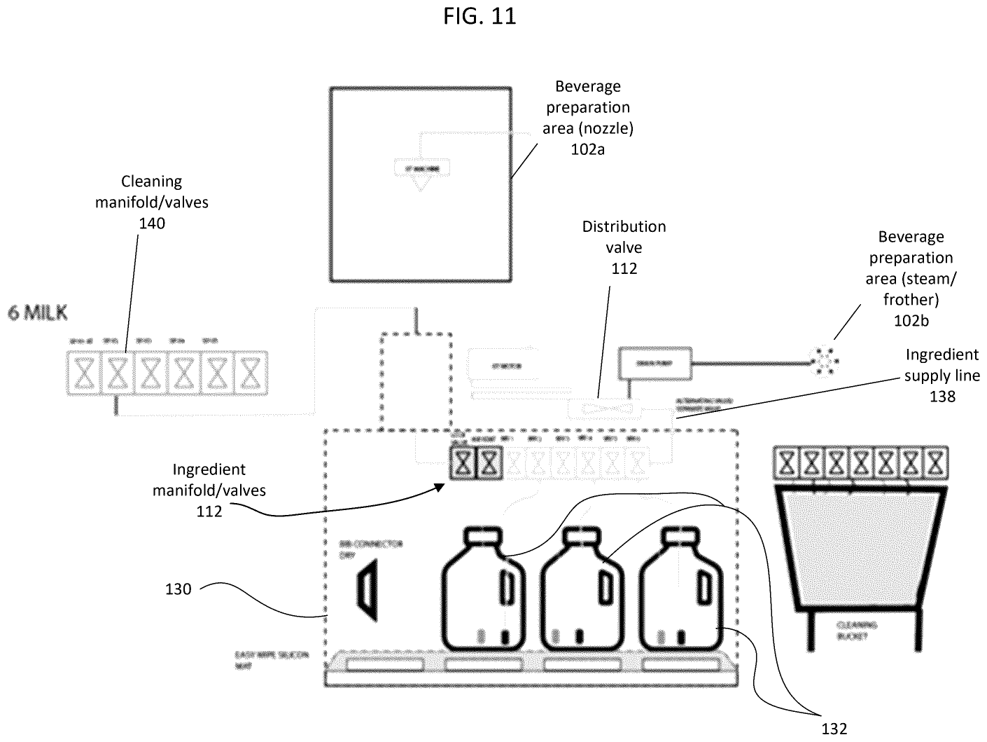

As noted above, a milk system “6M” may be configured to supply heated milk, milk froth, or any other milk product, e.g., to combine with coffee, espresso, or the like in a dispensed beverage. The milk subsystem may be cleaned similarly with a desired cleaning medium in one or more flushing/draining cycles to achieve a desired particulate matter removal and sanitization. Generally, it may be desired to collect cleaning medium for the milk system and bottles in a bucket or other vessel (see FIGS. 9 and 11) to expose both internal and external areas of the tubes to the cleaning solutions (e.g., diluted acid and alkaline). A sequencing facilitated by the processor may include, for example, system flush cycle(s), liquid dwelling cycle(s), and/or extra liquid drain cycle(s), or any combinations thereof.

As discussed above, the cold brew subsystem illustrated in FIG. 1 may generally be configured to supply a coffee or coffee-flavored beverage at a refrigerated temperature. In the illustrated example, fluid supplied as a cold brew cleaner may be supplied via a fitting to a bucket or vessel, and may employ cycles of flush, dwelling and draining to clean up and/or remove concentrates.

As noted above, example systems may be directed to cleaning a plurality of different beverage dispensing areas comprising different beverages. As noted above, different brewing engines or subsystems may have respective different cleaning processes. Example automated cleaning processes/subprocesses will now be described in further detail in connection with the example system 100a of FIG. 1.

In an example, a first brewing engine/system (e.g., “AT” Brew Chamber”) employs a coffee brew chamber cleaning workflow utilizing a non-diluted alkaline cleaning solution. Initially, a command is issued to the AT brew chamber to initiate an auto-clean procedure. For example, after a predetermined number of dispensing events by the AT brew chamber, or a predetermined volume of brewed liquid(s) has been dispensed, processing circuitry 114 may determine that a cleaning cycle is needed and according sends an instruction to initiate an automated cleaning process. The processing circuitry 114, for example, may control opening/closing of the “AT Brew Chamber Cleaning Alkaline INLET valve,” e.g., valve 112a associated with inlet 108a of cleaning source 106a, and the “AT Brew Chamber Cleaning Alkaline OUTLET valve,” e.g., valve 112b associated with outlet 110a of the cleaning source 106a, based on an internal timing and control logic. The brew chamber cleaning may take a predetermined period of time to complete, e.g., approximately 4 minutes.

A second brewing engine/system (“XT Brew Chamber”), by contrast, may employ a second respective cleaning process, which employs a non-diluted alkaline as the cleaning solution. Initially, a command may be issued, e.g., by processing circuitry 114, to initiate the brew chamber cleaning. This command may be issued in response to, for example, a determination that a number of cycles, volume of liquid dispensed, time period since last cleaning, time of day (e.g., overnight or during periods of non-use, etc. Initially, the alkaline cleaning solution may be dispensed into the brewing chamber by opening the inlet valve 108b and outlet valve 110b of the cleaning source 106b. After a predetermined time period on the order of a few seconds, e.g., six seconds, the inlet valve 108b and outlet valve 110b may be closed. The cleaning sequence may continue with a “dwelling” or wait period during a simulated door-open event, e.g., of sixty (60) seconds. Subsequently the cleaning process may continue with a further wait period, e.g., of 200 seconds, to complete cleaning.

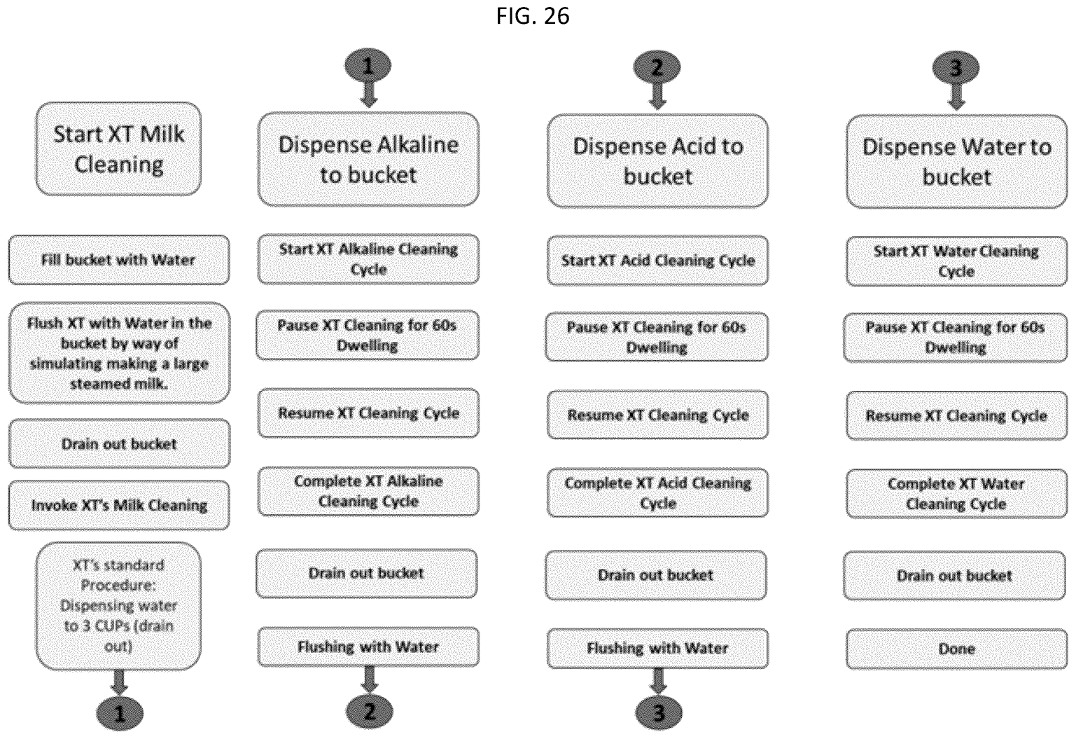

Furthermore, as noted above, a milk dispensing system may also have a respective cleaning process. In an example process illustrated at FIG. 26, an initial flushing process is employed (indicated by process flow to milestone 1 of FIG. 26), followed by a milk cleaning process including an alkaline cleaning (milestone 1 to milestone 2), an acid cleaning (milestone 2 to milestone 3), and rinsing/cleaning with water (milestone 3 to “Done”).

In the initial flushing phase, water is used to flush XT milk system, including the milk tubes, milk pump, the mixing bowl, and the dispense nozzle. A user or maintenance personnel may position a cleaning bucket in the cabinet 130, with the supply lines for milk each places in the cleaning bucket. Water may be flushed through the milk supply line by opening a valve 112 supplying fresh water into a first milk line for a predetermined period of time, e.g., 45 seconds. In an example, this will dispense roughly 800 milliliters of water into the cleaning bucket. The valve 112 may be closed to cut off the supply of fresh water to the milk supply line. Processing circuitry 114 may send a command to the XT brew group to make a large, steamed milk (“SM”) drink, i.e., with the water supplied to the milk subsystem. After a predetermined period of time, e.g., 40 seconds, the “drink” is completed. Subsequently an alternating valve 112 is actuated to turn on a drain pump to remove liquid from the cleaning bucket for a predetermined period of time, e.g., 20 seconds or otherwise to drain the bucket. The alternating valve 112 may be closed and the drain pump may then be stopped.

Following the flushing process, the milk cleaning process may proceed with dispensing alkaline, dispensing acid, and dispensing water. As reflected in FIG. 26, in at least some examples these three processes may include similar steps of starting the cleaning cycle by introducing the relevant cleaning medium, pausing or dwelling the cleaning medium for a predetermined period of time, resuming the cleaning cycle to completion, and draining the cleaning bucket.

Referring now to FIGS. 11, 16, and 17, an example refrigerated ingredient distribution system for an automated beverage dispenser is illustrated and described in further detail. In the illustrated example, the refrigerated ingredient distribution system is configured to dispense milk, cream, or other dairy/non-dairy liquids. The milk dispensing subsystem may generally be employed to dispense milk or other dairy products within the beverage dispensing system described herein, e.g., to facilitate creation of any dairy-containing beverages such as a cappuccino, latte, or the like. While the examples herein are directed to dispensing milk or dairy products, examples may dispense any liquid that is convenient.

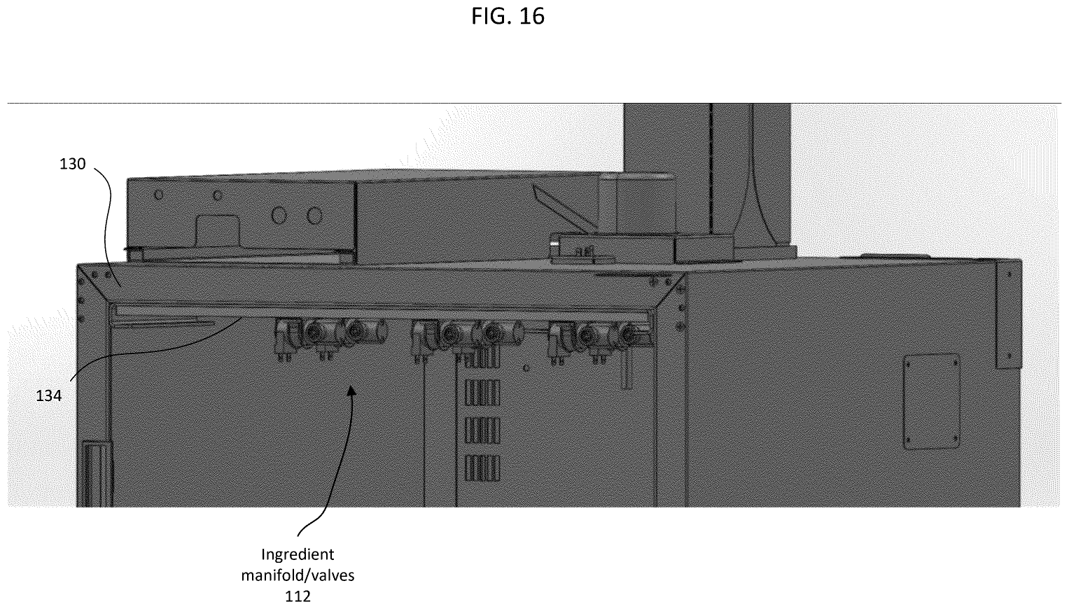

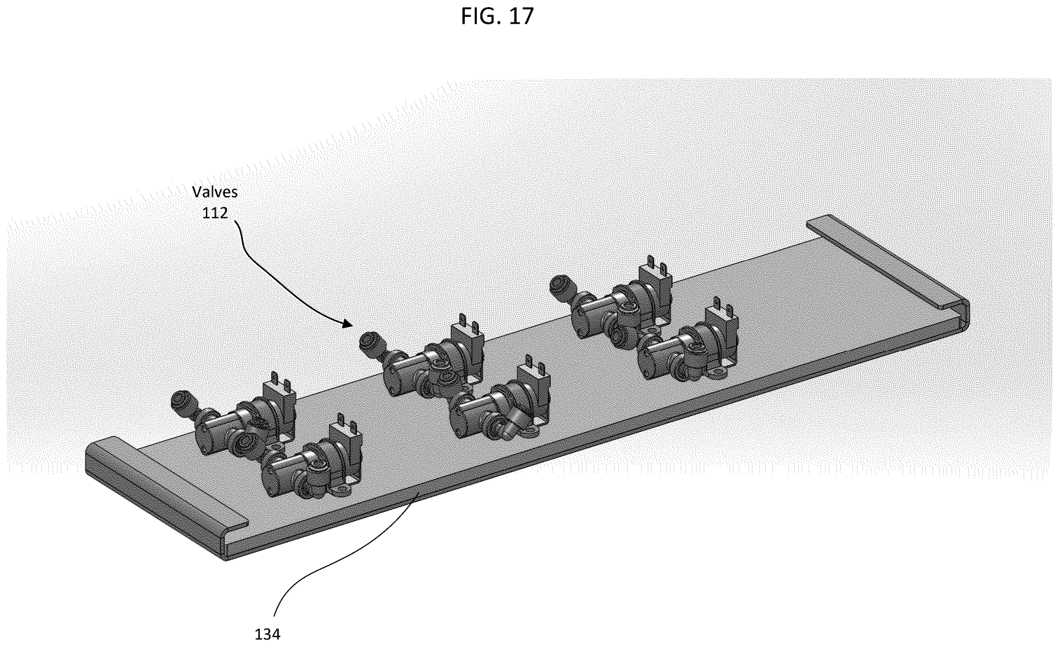

Referring now to FIG. 11, a milk dispensing subsystem 6M is illustrated and described in further detail. Milk dispensing subsystem 6M includes a cabinet 130 configured to store one or more containers of milk. In at least some examples, multiple containers 132 of milk may be stored in the cabinet 130, e.g., six gallon-jugs of milk. The cabinet 130 may be refrigerated to facilitate storage of the milk therein for a period time, e.g., until emptied from dispensing into beverages. A corresponding plurality of valves 112 may be positioned in an upper portion of the cabinet. For example, as illustrated in FIGS. 16 and 17, six valves 112, each corresponding to a different one of the six gallon-jugs 132 of milk, are mounted on a support plate 134 configured to be stored in an upper area of the cabinet 130. The plate 134 may be removable, e.g., for service or replacement of the valves 112 or other components attached to the plate 134. Otherwise, the plate 134 may be mounted along an upper portion or top of the cabinet 130, positioning each of the valves 112 above its respective container 132. Hoses 136 or other conduits may draw milk from the corresponding milk containers 132 to/through the valves 112 when milk is dispensed. The hoses 136 may be flexible to permit routing into each of the containers 132 such that an end 138 rests at/near a bottom of its respective container 132.

Milk may be drawn from each container 132 in any manner convenient to fulfill orders and distribute the milk into beverages. In the example illustrated in FIG. 11, an ingredient supply line 138 is connected to the plurality of valves (e.g., constant flow valves 112) with a manifold 142 or the like, and is configured to distribute milk from the plurality of valves 112 of the manifold 142 to a plurality of beverage preparation areas 102 of the automated beverage dispenser. For example, the ingredient supply line 138 may deliver milk from the valves 112 to a first beverage preparation area 102b having a frother configured to prepare steamed/foamed milk for a cappuccino, latte, or the like. The ingredient supply line may also deliver milk to another beverage preparation area 120a having a nozzle configured to deliver milk for a cold beverage, e.g., an iced latte beverage. Milk may be drawn to the valves 112 and through the ingredient supply line through a distribution valve 112 by way of respective pumps for the beverage preparation areas.

The milk dispensing subsystem may distribute milk or other liquid from the ingredient storage cabinet in any manner that is convenient. For example, the controller (see FIG. 1) may actuate valves, pumps, and other components of the beverage preparation system to draw milk from the ingredient storage cabinet to an appropriate beverage preparation area.

In an example, processing circuitry of the beverage preparation system (such as the controller 114 of FIG. 1) receives an order for a beverage, e.g., via a user interface, mobile device, or the like. The processing circuitry 114 may actuate valves 112, pumps, and other components of the beverage preparation system to deliver an amount and type of ingredient to fulfill the order. Accordingly, processing circuitry 114 may actuate valves 112 corresponding to ingredient containers in the ingredient storage cabinet to draw milk or other liquid to beverage preparation areas as needed. The processing circuitry 114 may be in communication with the plurality of valves 112 in the ingredient storage cabinet to enable appropriate valve(s) 112 to prepare beverage orders. In an example, the processing circuitry may determine from a recipe associated with a beverage order an amount and type of ingredient preparation, e.g., 3 ounces of foamed milk for a cappuccino order. The processing circuitry may thus determine a type of milk needed, such as whole milk, skim milk, half-and-half, etc. The processing circuitry 114 may also determine which container(s) 132 in the ingredient storage cabinet contain enough of the required ingredient to fulfill the order. For example, as illustrated in FIG. 11 each of the containers 132 may rest upon a weight sensor 140 configured to determine an amount of liquid/ingredient present within each container 132. The processing circuitry 114 may draw from appropriate containers 132 to prepare ordered beverages. In an example, the processing circuitry 114 may, in the course of preparing a first beverage, actuate a first valve 112 to draw milk from a first one of the plurality of containers. The processing circuitry may subsequently determine, in the process of fulfilling a later beverage order, that the first container does not contain enough of the required ingredient to meet the order, e.g., less than a required amount of milk. Accordingly, the processing circuitry may, in response to a determination that the first one of the plurality of containers contains an amount of the ingredient below a threshold amount, enable a different valve. Accordingly, the processing circuitry 114 may draw the ingredient from a different one of the containers 132, which has been determined to contain enough of the ingredient to meet the beverage order.

The milk dispensing system may be configured to be cleaned using the automated cleaning system described above. In an example, processing circuitry 114 may determine the need to implement a cleaning cycle, e.g., based upon expiration of a timer, counter, or the like. Cleaning of the milk distribution system may be executed manually by service personnel of the beverage preparation system. As illustrated in FIG. 11, a plurality of cleaning valves (e.g., constant flow valves 112) may be provided in a cleaning valve manifold 140 in communication with the plurality of valves in the ingredient storage cabinet. During a cleaning process, service personnel may remove the beverage containers 132 from the ingredient storage cabinet and place the flexible conduits into a cleaning bucket (not shown in FIG. 11). A cleaning medium may be circulated from a cleaning valve manifold, through the distribution valve manifold and each of the flexible conduits. Accordingly, the cleaning medium may generally flush the milk distribution system into the cleaning bucket. The cleaning bucket may generally be sized or otherwise configured to contain the plurality of flexible conduits, as well as the cleaning fluid circulated from the cleaning system through the flexible conduits.

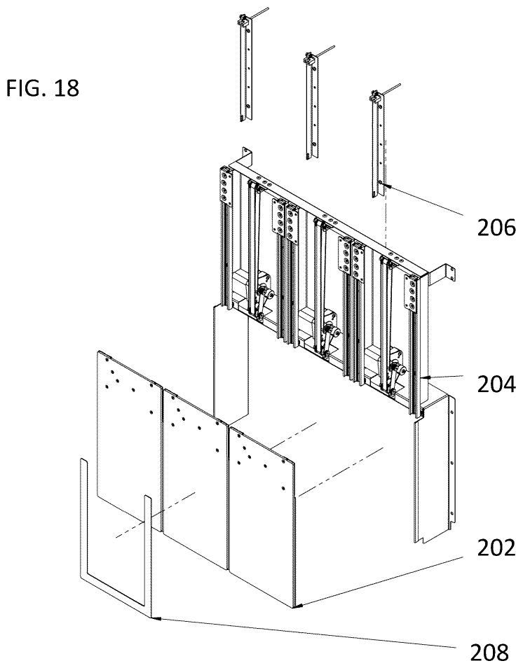

Referring now to FIGS. 18-25, an automated access door system 200 is illustrated and described in further detail. In an example, the automated access door system 200 may be employed in the context of an automated beverage preparation or distribution system. The beverage preparation system may have a serving area, e.g., beverage preparation area 102, that is generally enclosed, e.g., to limit or prevent access to an area in which prepared beverages are placed for pickup or retrieval by a customer.

As shown, for example, in FIG. 18, the automated access door system 200 may have a plurality of moveable door panels 202 that are independently movable by respective drive motors or systems. Each door panel 202 may be actuated by a roll-up motor 204. The automated access door system 200 may also include sensors 206 and a gap cover 208.

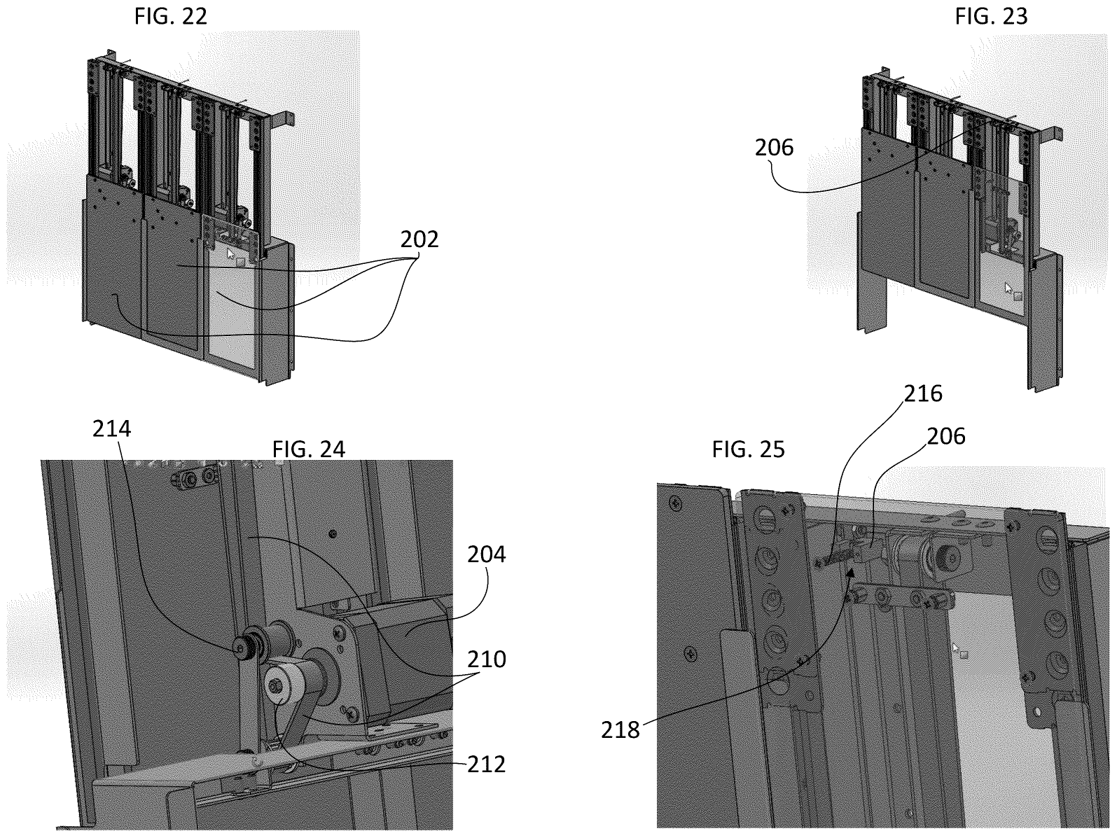

For example, as illustrated in FIGS. 22-25, each of the door panels 202 may have a respective drive motor 204 and belt 210 configured to lift the door panel 202. Each drive motor 204 may have a drive wheel 212 engaged with the belt 210, which carries each door. Accordingly, each door panel 202 may be independently raised/lowered via its respective drive motor 204. The door panels 202 may each be carried by their respective belt 210 with a clip or other mechanism that slips relative to the belt when a threshold force is exceeded, e.g., as may occur if the door panel 202 is obstructed while the drive motor 204 is closing the door panel 202. One or more belt tensioning wheels 214 or pulleys may be provided to tension the belt 210, and/or to facilitate adjustments of tension of the belt 210.

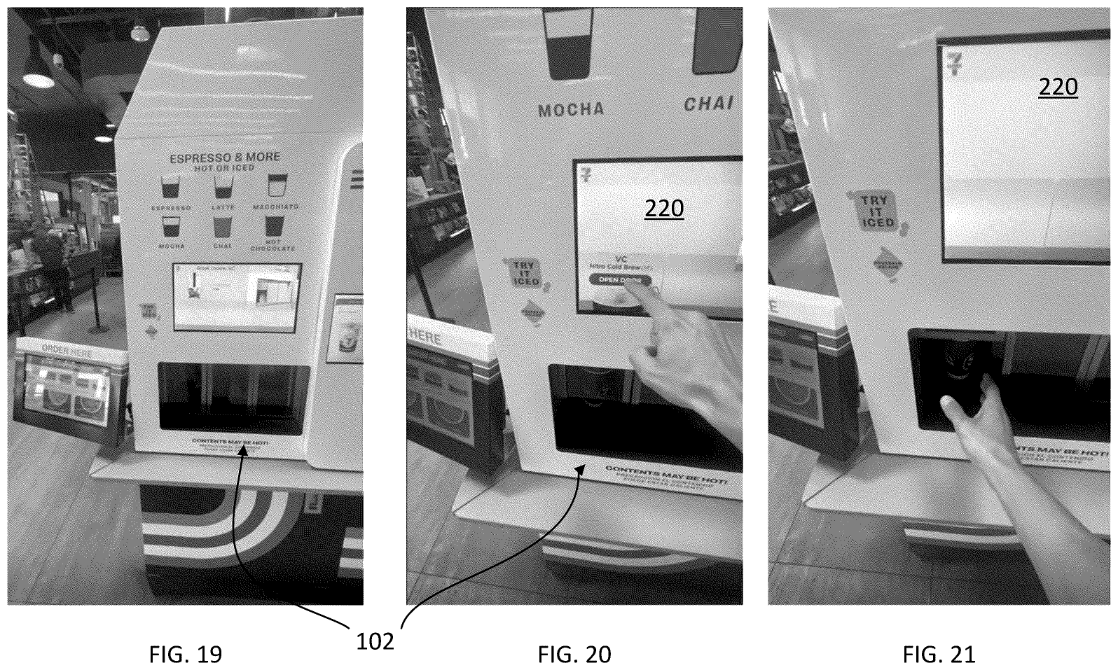

Each of the door panels 202 may correspond to a respective portion of the enclosed beverage serving area 102, as seen in FIGS. 19-21. Accordingly, depending on which portion of the beverage serving area corresponds to a dispensed beverage, the corresponding door panel 202 may be opened to allow a customer to reach into the enclosed beverage service area 102 to withdraw the beverage. In an example, each of the doors 202 may act as a queueing mechanism for beverage orders. More specifically, a customer may order a drink via the beverage dispensing system, and may continue shopping elsewhere in the store/location while the beverage is being prepared. Once preparation of the beverage is finished, the beverage may be placed within the enclosed area 102 behind the doors 202, thereby protecting the beverage from being taken, spilled, etc. The customer may receive a confirmation that their beverage is ready, e.g., via a screen/display of the system, via a customer application on a customer mobile device, or the like. The customer may then confirm they are ready to take possession of their beverage, e.g., by indicating via a selection entered on the beverage dispensing system screen 220, or via the mobile application. In response, the door 202 associated with where the prepared beverage has been placed may be opened by the respective drive motor 204/belt 210.

The enclosed area behind the door panels may have one or more sensors 206 configured to detect placement/completion of the beverage, and/or when a customer reaches into the enclosed area 102 upon opening of one or more of the door panels 202. For example, a light curtains sensor may detect that a customer has placed their hand within the enclosed area. Additionally, sensor(s) 206 may be provided configured to detect when each door panel 202 is in a fully opened position. In the example illustrated in FIG. 25, a threaded member 216 carried by a door panel (shown translucent in FIG. 25) may extend into a sensor cavity 218 of the sensor 206 when the door panel 202 is fully raised. Accordingly, the beverage dispensing system may be configured to maintain the doors 202 in the fully raised position while a customer is reaching into the enclosed area 102 to retrieve the beverage. The door panel(s) 202 may be lowered after the beverage dispensing system determines that the customer has withdrawn their hand, and/or after the expiration of a timer following the customer's hand having been withdrawn from the enclosed area.

The automated access door system may include processing circuitry, e.g., the controller 114 (see FIG. 1), configured to move the door panel(s) 202 in response to beverage orders and dispensing. After the door(s) 202 are moved, the customer may access the enclosed beverage service area 102 to withdraw their beverage. Subsequently, the door panel(s) 202 may be moved back into place to enclose the beverage service area. In an example, the motor 204/belt drive 210 system may be actuated in a reverse direction, thereby moving the door panel(s) 202 back into position to enclose the beverage service area. In some examples, processing circuitry 114 may determine that a dispensed beverage has been removed from the beverage serving area, and based upon that determination may reverse movement of the door(s) 202 to enclose the beverage serving area. Additionally, the processing circuitry 114 may be configured to determine that movement of the door(s) 202 is obstructed, and to stop movement or reverse movement based on such determination. In an example, the motor 204/belt drive is electrically actuated, and an obstruction may be detected via a surge in a current draw of the motor 204. The system, e.g., by way of processing circuitry 114, may be configured to stop movement of one or more of the door(s) 202 based on a determination that the door(s) 202 is/are obstructed.

The following numbered paragraphs set forth additional examples, in accordance with the foregoing detailed description:

Numbered paragraph 21. A refrigerated ingredient distribution system for an automated beverage dispenser, comprising:
a storage cabinet configure to store an ingredient at a refrigerated temperature, wherein the ingredient is stored in a plurality of containers;
a plurality of valves corresponding to the plurality of containers;
an ingredient supply line configured to distribute the ingredient from the plurality of valves to a plurality of beverage preparation areas of the automated beverage dispenser; and
processing circuitry in communication with the plurality of valves to:
   enable, at a first time associated with preparation of a first beverage, a first one of the valves to draw the ingredient from a first one of the plurality of containers;
   based on a determination that the first one of the plurality of containers contains an amount of the ingredient below a threshold amount, enable a second one of the valves to draw the ingredient from a second one of the plurality of containers, wherein the second time is after the first time, and wherein the second time is associated with preparation of a second beverage.
      Numbered paragraph 22. The refrigerated ingredient distribution system of numbered paragraph 21, wherein the threshold amount is based upon a recipe included in preparation of the second beverage.
      Numbered paragraph 23. The refrigerated ingredient distribution system of numbered paragraph 21, further comprising a plurality of flexible conduits, each corresponding to a respective one of the valves, each of the flexible conduits configured to draw the ingredient from a respective one of the containers.
      Numbered paragraph 24. The refrigerated ingredient distribution system of numbered paragraph 23, further comprising a cleaning bucket configured to contain the plurality of flexible conduits and contain a cleaning fluid circulated from a cleaning system through the flexible conduits.
      Numbered paragraph 25. An automated access door system for a beverage distribution system, comprising:
a plurality of moveable door panels, each corresponding to a respective portion of an enclosed beverage serving area;
at least one motor drive for the plurality of moveable door panels; and
processing circuitry in communication with the at least one motor drive to:
   move a first one of the doors corresponding to a first beverage prepared by the beverage distribution system, thereby allowing customer access to the enclosed beverage serving area; and
   after the first door is moved, reverse movement of the first one of the doors to prevent customer access to the beverage serving area.
      Numbered paragraph 26. The automated access door system of numbered paragraph 25, wherein the processing circuitry is configured to move one or more of the plurality of doors based on an ordered beverage being delivered to a corresponding one or more of the respective portions of the enclosed beverage serving area.
      Numbered paragraph 27. The automated access door system of numbered paragraph 25, wherein the processing circuitry is configured to reverse movement of the first one of the doors based on a determination that the first beverage has been removed from the beverage serving area.
      Numbered paragraph 28. The automated access door system of numbered paragraph 25, wherein the processing circuitry is configured to stop movement of the first one of the doors based on a determination that first one of the doors is obstructed.
      Numbered paragraph 29. The automated access door system of numbered paragraph 28, wherein the processing circuitry is configured to determine that first one of the doors is obstructed based on a current draw of the at least one motor drive.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A cleaning system for an automated beverage dispenser, comprising:
a plurality of beverage preparation areas;
a fluid supply line, wherein the fluid supply line provides a fluid path for a pressurized fluid;
a cleaning medium source;
a first controllable constant flow valve located between the fluid supply line and the cleaning medium source, wherein activating the first controllable constant flow valve allows the pressurized fluid to be provided to the cleaning medium source at a first flow rate of the first controllable constant flow valve such that an output of the cleaning medium source has a particular concentration of the cleaning medium;
a second controllable constant flow valve coupled to the output of the cleaning medium source to provide the output of the cleaning medium source with the particular concentration to a first beverage preparation area of the plurality of beverage preparation areas at a second flow rate of the second controllable constant flow valve; and
processing circuitry in communication with the first controllable constant flow valve and the second controllable constant flow valve to:
enable, at a first time associated with a beginning of a cleaning cycle of the first beverage preparation area, the first controllable constant flow valve;
enable, at a second time after the first time and while the first controllable constant flow valve remains enabled, the second controllable constant flow valve; and
disable, after an end of the cleaning cycle of the first beverage preparation area, the first controllable constant flow valve and the second controllable constant flow valve.

2. The cleaning system of claim 1, further comprising a third controllable constant flow valve coupled to the output of the cleaning medium source to provide the output of the cleaning medium source with the particular concentration to a second beverage preparation area of the plurality of beverage preparation areas at a third flow rate of the third controllable constant flow valve, wherein the processing circuitry is further in communication with the first controllable constant flow valve and the third controllable constant flow valve to:
enable, at a third time associated with a beginning of a cleaning cycle of the second beverage preparation area, the first controllable constant flow valve;
enable, at a fourth time after the third time and while the first controllable constant flow valve remains enabled, the third controllable constant flow valve; and
disable, after an end of the cleaning cycle of the second beverage preparation area, the first controllable constant flow valve and the third controllable constant flow valve.

3. The cleaning system of claim 1, further comprising a third controllable constant flow valve located between the fluid supply line and the cleaning medium source, wherein activating the third controllable constant flow valves allows the pressurized fluid to be provided to the cleaning medium source at a third flow rate of the third controllable constant flow valve such that an output of the cleaning medium source has a second particular concentration of the cleaning medium, wherein the processing circuitry is further in communication with the second controllable constant flow valve and the third controllable constant flow valve to:
enable, after the first controllable constant flow valve is disabled and at a third time associated with a portion of the cleaning cycle including the second particular concentration, the third controllable constant flow valve;
enable, at a fourth time after the third time and while the third controllable constant flow valve remains enabled, the second controllable constant flow valve; and
disable, after an end of the cleaning cycle of the first beverage preparation area, the second controllable constant flow valve and the third controllable constant flow valve.

4. The cleaning system of claim 1, further comprising a third controllable constant flow valve located between the fluid supply line and the first beverage preparation area, wherein the processing circuitry is further in communication with the third controllable constant flow valve to provide the fluid to the first beverage preparation area at a third flow rate of the third controllable constant flow valve during the cleaning cycle.

5. The cleaning system of claim 1, further comprising:
a second cleaning medium source;
a third controllable constant flow valves located between the fluid supply line and the second cleaning medium source, wherein activating the third controllable constant flow valves allows the pressurized fluid to be provided to the second cleaning medium source at a third flow rate of the third controllable constant flow valve such that an output of the second cleaning medium source has a second particular concentration of the second cleaning medium; and
a fourth controllable constant flow valve coupled to the output of the second cleaning medium source to provide the output of the second cleaning medium source with the second particular concentration to the first beverage preparation area of the plurality of beverage preparation areas at a fourth flow rate of the fourth controllable constant flow valve, wherein the processing circuitry is in communication with the third controllable constant flow valve and the fourth controllable constant flow valve to:
enable, at the first time, the third controllable constant flow valve;
enable, at the second time and while the third controllable constant flow valve remains enabled, the fourth controllable constant flow valve; and
disable, after an end of the cleaning cycle of the first beverage preparation area, the third controllable constant flow valve and the fourth controllable constant flow valve.

6. The cleaning system of claim 5, wherein the cleaning medium source comprises an alkaline and the second cleaning medium source comprises an acid.

7. The cleaning system of claim 1, wherein the cleaning medium source is modular and replaceable, and wherein the processing circuitry is further configured to modify the enabling and disabling of the first controllable constant flow valve or the second controllable constant flow valve to modify the particular concentration of the cleaning medium to the first beverage preparation area.

8. The cleaning system of claim 7, wherein the modification comprises changing a flow rate of the first controllable constant flow valve.

9. The cleaning system of claim 1, further comprising one or more of a heater, a concentrate pump, or a spray nozzle coupled to prepare an output of the second controllable constant flow valve for delivery to the first beverage preparation area.

10. The cleaning system of claim 1, wherein the processing circuitry is configured to begin the cleaning cycle based on a number of beverage dispensing cycles since a previous cleaning cycle, an amount of time since the previous cleaning cycle, a type of beverage dispensed since the previous cleaning cycle, environmental conditions, and/or beverage dispensing components.

11. The cleaning system of claim 1, wherein the processing circuitry is configured to receive feedback during the cleaning cycle and modify the cleaning cycle based on the feedback.

12. The cleaning system of claim 11, wherein the modification to the cleaning cycle comprises a modification of the particular concentration the cleaning medium.

13. The cleaning system of claim 11, wherein the modification to the cleaning cycle comprises a modification of the time that the particular concentration of the cleaning medium is provided to the first beverage preparation area.

14. The cleaning system of claim 11, wherein the modification to the cleaning cycle comprises a modification of a heating an output of the second controllable constant flow valve.

15. The cleaning system of claim 11, wherein the feedback comprises a cleaning time, a cleaning temperature, and/or a presence of debris.

16. A cleaning system for an automated beverage dispenser, comprising:
a plurality of cleaning areas;
a fluid supply line, wherein the fluid supply line provides a fluid path for a pressurized fluid;
a cleaning medium source;
a first controllable constant flow valve located between the fluid supply line and the cleaning medium source, wherein activating the first controllable constant flow valve allows the pressurized fluid to be provided to the cleaning medium source at a first flow rate of the first controllable constant flow valve such that an output of the cleaning medium source has a particular concentration of the cleaning medium;
a second controllable constant flow valve coupled to the output of the cleaning medium source to provide the output of the cleaning medium source with the particular concentration to a first cleaning area of the plurality of cleaning areas at a second flow rate of the second controllable constant flow valve; and
processing circuitry in communication with the first controllable constant flow valve and the second controllable constant flow valve to:
enable, at a first time associated with a beginning of a cleaning cycle of the first cleaning area, the first controllable constant flow valve;
enable, at a second time after the first time and while the first controllable constant flow valve remains enabled, the second controllable constant flow valve; and
disable, after an end of the cleaning cycle of the first cleaning area, the first controllable constant flow valve and the second controllable constant flow valve.

17. The cleaning system of claim 16, wherein a cleaning area of the plurality of cleaning areas comprises a plurality of dispensing nozzles.

18. The cleaning system of claim 16, wherein a cleaning area of the plurality of cleaning areas comprises a cleaning basin.

19. The cleaning system of claim 18, further comprising a dispensing connector located proximate a bottom of the cleaning basin, wherein the dispensing connector provides a fluid source for cleaning of a dispensing device.

20. The cleaning system of claim 19, further comprising a concentrate pump coupled between the dispensing connector and the dispensing device to provide the fluid to the dispensing device at a desired pressure.
